(19) United States
(12) Patent Application Publication
(10) Pub. No.: US 2004/0107251 A1
(43) Pub. Date: Jun. 3, 2004

(54) System and method for communicating expressive images for meetings

(76) Inventors: Hansen Wat, Redwood Shores, CA (US); Carol Sue Hidy Suess, Redmond, WA (US)

Correspondence Address: HEWLETT-PACKARD COMPANY, Intellectual Property Administration, P.O. Box 272400, Fort Collins, CO, 80527-2400, US

(21) Appl. No.: 10/623,172

(22) Filed: Jul. 21, 2003

Related U.S. Application Data
(63) Continuation-in-part of application No. 09/955,044, filed on Sep. 19, 2001.

(51) Int. Cl. G06F 15/16; G09G 5/00

(52) U.S. Cl. 709/204; 345/706

(57) ABSTRACT

A method and system use networked computers to allow meeting participants to communicate expressive images for remote meetings. Meeting participants may select and display photographs of themselves to other meeting participants, thus communicating expressive images during meetings without interrupting the discussion and presentations that are taking place. The expressive images may be transmitted over a network to other meeting participants.

### CROSS REFERENCE TO RELATED APPLICATION(S)

This application is a continuation-in-part of application Ser. No. 09/955,044, filed Sep. 19, 2001 entitled A FRAME FOR COMMUNICATING EXPRESSIVE INFORMATION FOR MEETINGS, which is incorporated herein by reference.

### TECHNICAL FIELD

The technical field relates to communication systems, and, in particular, to a system and method for communicating expressive images for meetings.

### BACKGROUND

Remote meetings such as telephone conferences have long been crippled because participants cannot effectively convey or exchange important expressive information with the whole group. During a remote presentation, very often no one voices confusions or concerns, because each participant, unable to observe other participants' similar reactions, commonly thinks that he/she is the only one who is confused, concerned, etc., and is therefore reluctant to speak up. Similarly, a speaker making a remote presentation typically is unsure when to stop explaining, since he/she cannot readily observe the audience's reactions such as dawning comprehension, growing impatience, or dismissive boredom. As a result, important questions and objections are often not raised, and too much time is spent explaining what is already understood.

Similar dynamics may take place during a cross-cultural group meeting when participants cannot confidently interpret the signals that other participants send through their facial expressions, gestures, stance, and general demeanor. Participants may feel so isolated that they refrain from voicing their contributions to discussions, while leaders may have trouble setting meeting pace appropriately and leading discussions effectively.

Some existing remote meeting tools enable participants to send short messages containing text and/or icons to a leader or a moderator of the meeting. However, the messages are typically available only to the leader or the moderator, and other participants cannot use the messages to gauge the flow and tenor of the other participants' reactions. This makes it impossible for participants to participate in and contribute to the meeting's group dynamics as they would in a face-to-face meeting.

Remote meeting participants sometimes use text chat to augment telephone conferencing. However, two important limitations relate to the text chat. First, in many cases the text chat is not visible to the entire group (who may be completely unaware that the text chat is taking place), but serves as a sidebar conversation among a subset of the participants, who may be drawn together by their communication, but who are also isolated from the others who are left out. Therefore, when text chat is used in the absence of any means of ongoing communication among the group as a whole, it can serves more to fragment the meeting than to contribute to a healthy, robust inclusive group dynamic. Second, the text chat tends to be keyboard-intensive, requiring the same kind of attention and mental processing as the meeting's main discussion. Therefore, the text chat often competes with the main discussion of the meeting for the participants' mind share. When feelings run high or a topic under discussion calls for concentration, the participants generally chose one or the other: they either abandon the text chat, or they abandon the main discussion and simply vent feelings in the text chat. Third, as participation increases, the speed with which information in a chat window scrolls up and off the page increases, i.e., the more people contribute, the faster the contributions disappear, and the harder for the participants to follow the text chat, especially when they are simultaneously trying to follow the thread of the main presentation or discussion. Accordingly, while a text chat window may be adequate for communicating reactions of a few participants among themselves, the text chat is inadequate for communicating expressive information among a large group of participants.

Remote meeting participants have also tried to use video transmission as a medium for expressing and exchanging reactions. However, video is bandwidth intensive. Therefore, using video to provide visual feedback requires fast computer processors and network connections. Even when high-speed computer processors and network connections are used, delay (“lag”) tends to be present in varying degrees, making it difficult if not impossible to correctly interpret which exact antecedent event triggered a particular response. Furthermore, video cameras do not provide feedback effectively because expressive information is typically communicated through complex, highly-nuanced, and language/cultural-specific expressions, postures, and gestures. Even if network bandwidth and computer power are able to accommodate multiple video transmissions, trying to watch an array of video windows proves to be inadequate. The signals (intended messages) each person sends are moreover subject to being distorted and obscured by many meaningless expressions, postures, and actions (visual “noise”) which are simply part of living and working. Unlike professional actors who can focus entirely on conveying a specific message through a camera, meeting participants must focus on the subject of the meeting and the meeting itself.. Accordingly, the nuances of body language that depend on physical proximity and eye contact simply cannot be conveyed through independent videos. In addition, trying to follow multiple video images simultaneously may be distracting and tiresome for participants.

### SUMMARY

The embodiments described herein overcome the disadvantages described above. A system for communicating expressive images for a meeting includes a plurality of computers controlled by meeting participants and a storage device capable of storing one or more collections of expressive images of each meeting participant. The system further includes a software application enabling each meeting participant to select an expressive image from the one or more collections of expressive images and a network connecting the plurality of computers. Each meeting participant communicates the selected expressive image to other meeting participants over the network during the meeting.

A corresponding method for communicating expressive images for a meeting includes launching a software application on a computer controlled by a meeting participant, connecting the computer to other meeting participants' computers over a network, enabling the meeting participant to select an expressive image from one or more collections of expressive images stored in a storage device, and communicating the selected first expressive image to other meeting participants' computers over the network during the meeting.

A computer readable medium providing instruction for communicating expressive images for meetings. The instructions includes launching a software application on a computer controlled by a meeting participant, connecting the computer to other meeting participants' computers over a network, enabling the meeting participant to select a first expressive image from one or more collections of expressive images stored in a storage device, and communicating the selected first expressive image to other meeting participants' computers over the network during the meeting.

### DESCRIPTION OF THE DRAWINGS

The detailed description will refer to the following drawings, wherein like numerals refer to like elements, and wherein:

FIG. 1 illustrates an embodiment of hardware components of a computer that may be used in connection with an exemplary method for communicating expressive images for meetings;

FIG. 2 shows an embodiment of an exemplary photo display window and photo control window that may be used in connection with an exemplary method for displaying expressive images for meetings;

FIGS. 3-5 illustrate embodiments of exemplary network connection models that may be used in connection with an exemplary method for communicating expressive images for meetings; and

FIG. 6 is a flow chart illustrating an embodiment of an exemplary method for communicating expressive images for meetings.

### DETAILED DESCRIPTION

A method and system use networked computers to allow meeting participants to communicate expressive images for remote meetings, or for cross-cultural or other face-to-face meetings where participants cannot confidently and correctly interpret the signals that other participants send through their facial expressions, gestures, stance, and general demeanor. Meeting participants may select and display photographs of themselves to other meeting participants, therefore communicating expressive images during meetings without interrupting the discussion and presentations that are taking place. The expressive images may be transmitted over a network to other meeting participants. Every meeting participant may view the transmitted expressive images displayed on a computer connected to the network. Alternatively, a meeting participant can select one or more meeting participants and only transmit the expressive images to a few computers operated by the selected meeting participants.

The system enables remote and local meeting participants in a meeting to exchange expressive personal information, referred to as murmur information. Meeting participants can express their own reactions and insights, and can receive other participants' communications through the same system with a good likelihood of correctly interpreting other participants' reactions and insights. Murmur information is traditionally provided by the participants' expressions, stance, actions, and verbal asides in face-to-face interactions. Murmur information may include some or all of the following: each participant's reactions to a subject matter of a discussion; status in relation to a meeting, such as waiting to ask a question or being briefly called away; thoughts; intentions; and other relevant activities. Murmur information may be communicated to the entire group without interrupting the main threads of the meeting by any of the participants. Speakers, moderators, and participants may all rely on murmur information for guidance in working effectively with the group's continually-unfolding dynamics.

The system is more advantageous than transmitting video when used to enable all meeting participants to engage in ongoing communication among themselves because image display may be less distracting than video. For example, when video is used to show a main speaker, and expressive images are used for all other participants, participants attention may be drawn primarily to the main speaker, and secondarily to any image-changes made by other participants. This method encourages an appropriate balance of attention. The system also reduces miscues and misunderstandings. For example, when someone in a video conference makes a face at a computer problem, the speaker may mistakenly assume that the expression is a reaction to what the speaker said. That misunderstanding would not arise if this system were being used instead of video, because the participant's grimace at his or her computer would not be seen, and the participant would not deliberately send an expressive image communicating an irrelevant reaction. Similarly, a delay in seeing the expression due to network congestion may also lead to misinterpretation of the expression. Because the system is far less bandwidth intensive than video, the incidence of delays due to network congestion is far less with the system than with video, with a corresponding decrease in misunderstandings due to delays. Further, because with the system each individual deliberately chooses when to display selected images, and because individuals can discuss and be take into consideration whatever degree of delay various participants are experiencing, images can be selected which have a more prolonged relevance to the discussion, as opposed to the fleeting and very time-sensitive expressions captured by video, further reducing the opportunities for misinterpretations. In addition, communicating expressive images offers greater precision and control for meeting participants, because the meeting participants can pre-screen and select images to accurately convey what they choose to express. Furthermore, communicating expressive images requires less ongoing self-consciousness from the meeting participants, since they are not “on camera” with their every move subject to scrutiny and potential misinterpretation. Additionally, sending expressive images is much less resource-intensive than sending video. As a result, many meeting participants may be able to exchange expressive images without fast computer processors or fast network connections. An additional benefit of using expressive images prepared in advance over real-time video is that expressive images eliminate the participants' need to prepare their appearance and the appearance of the space around them to be appropriate to the meeting. This is especially beneficial in cases where several remote meeting with different “dress codes” are scheduled with little or no time between. In stead of needing to change his or her real-life appearance, the participant can simply select photos that show him or her dressed in the appropriate degree of formality. In addition, since the participants' work space need not function as a video studio, the work space can retain whatever tools and materials that are needed for work, regardless of whether or not the tools and materials would present an impression of clutter if seen in video.

The system also offers a better alternative to emoticons because meeting participant can select photographs of themselves, which serve as a visual and memory aid for the meeting. Therefore, the system overcomes the sense of faceless anonymity that can be a disadvantage in remote meetings.

Furthermore, the system provides a way for remote meeting participants and remote team members to follow the same behavior pattern that people use face-to-face, i.e., beginning with a few pleasant, fairly neutral and somewhat guarded expressions, and gradually expanding the range of expression as the meeting participants know each other well enough that their expressions will be correctly interpreted.

A subtle but significant difference exists between using expressive images, such as still photographs, to illustrate a person's reactions, and using video intended to capture the person's real-time expressions. The distinction is related to the need to distinguish between significant expressions (signals) and meaningless actions (noise). Any and all movements, including facial changes, stance, movement, etc., may be either signal or noise, depending on whether they are intended to convey meaning or are simply related to living and working. In face-to-face interactions, highly-developed social conventions enable persons to frame each action as meaningful or meaningless, and insofar as other individuals are conversant with the same social conventions they are able to correctly filter out some actions as meaningless and focus on other actions as meaningful. Most of the social conventions related to framing actions as meaningful or meaningless have not yet been adapted for use through an unedited video medium. Therefore, video communication may contain a high ratio of noise (meaningless actions) to signal (meaningful actions), and people observing others in an unedited video may not be able to distinguish clearly between the two. Therefore, people may be burdened by not being able to preemptively dismiss the large percentage of actions that are meaningless. In these circumstances the flow of ambiguous input commonly becomes so overwhelming that participants often resort to ignoring the input altogether, thus losing the signal along with the noise.

Using illustrative photographs prepared in advance solves the noise problem, since meaningless actions are not observed. Using pre-prepared illustrative photographs shows the individuals themselves and their styles of expressing themselves, which enables other meeting participants to envision and become acquainted with each other in ways that are not empowered by the use of stylized icons.

The system for communicating expressive images for remote meetings includes one or more computers connected through a network. The computers may be located remotely and controlled by meeting participants. The computers may alternatively be computing devices with reduced functionality for use in special circumstances, for example, when a meeting participant is traveling. Such a reduced functionality computing device may display text associated with images, such as comments or descriptive titles which participants may assign to their prepared photos, without displaying the images themselves.

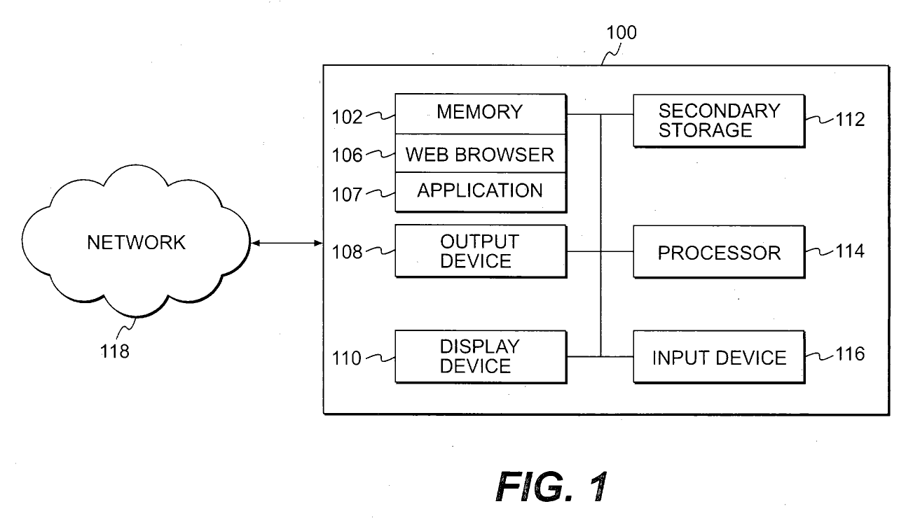

FIG. 1 illustrates exemplary hardware components of a computer 100 that may be used to in connection with the system and an exemplary method for communicating expressive images for meetings. The computer 100 includes a connection with a network 118, such as the Internet or other type of computer or telephone networks. The network enables the computers 100 to send and receive files and other information. The computer 100 typically includes a memory 102, a secondary storage device 112, a processor 114, an input device 116, a display device 110, and an output device 108.

The memory 102 may include random access memory (RAM) or similar types of memory. The memory 102 may be connected to the network 118 by a web browser 106. The web browser 106 makes a connection by way of the world wide web (WWW) to other computers, and receives information from the other computers that is displayed on the computer 100. The secondary storage device 112 may include a hard disk drive, floppy disk drive, CD-ROM drive, or other types of non-volatile data storage, and it may correspond with various databases or other resources. The expressive images of meeting participants may be stored in the secondary storage device 112 on each participant's computer 100. The processor 114 may execute applications or other information stored in the memory 102, the secondary storage 112, or received from the Internet or other network 118. For example, the processor 114 may execute a software application 107 used in connection with an exemplary method for communicating expressive images for meeting. The input device 116 may include any device for entering data into the computer 100, such as a keyboard, key pad, cursor-control device, touch-screen (possibly with a stylus), or microphone. The display device 110 may include any type of device for presenting visual image, such as, for example, a computer monitor, flat-screen display, television screen, or display panel. Expressive images of meeting participants may be displayed on the display device 110. The output device 108 may include any type of device for presenting data in hard copy format, such as a printer, and other types of output devices including speakers or any device for providing data in audio form. The computer 100 can possibly include multiple input devices, output devices, and display devices.

Although the computer 100 is depicted with various components, one skilled in the art will appreciate that this computer can contain additional or different components. In addition, although aspects of an implementation consistent with the method for communicating expressive images are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 100 to perform a particular method.

Each meeting participant may have access to a computer 100 connected to other meeting participants' computers 100 through a network 118. More than one participant may share a computer 100, in which case the expressive images displayed may be considered as representing the participants' reactions as a group unless otherwise specified, and the expressive images may in fact include all of the people so sharing. The software application 107 on the computers 100 enables the meeting participants to select images for display on other meeting participants' computers 100. The software application 107 also enables each meeting participant to view the images displayed on his or her computer 100. The software application 107 preferably generates two windows. A photo display window displays expressive images of the meeting participants. A photo control window enables each participant to select expressive images from his or her personal image collections to be displayed over the network 118 during a meeting. The meeting participants may express real-time responses to meeting events and discussions by displaying different expressive images over the network 118.

The display device 110 of each participant's computer 100 may display multiple expressive images of other meeting participants in the meeting. A participant's name may be associated with his or her image for identification. The images and names may be shown positioned in any meeting formation on the user's display device 110, such as around a conference table, in a “horseshoe” theater seating, or other formations.

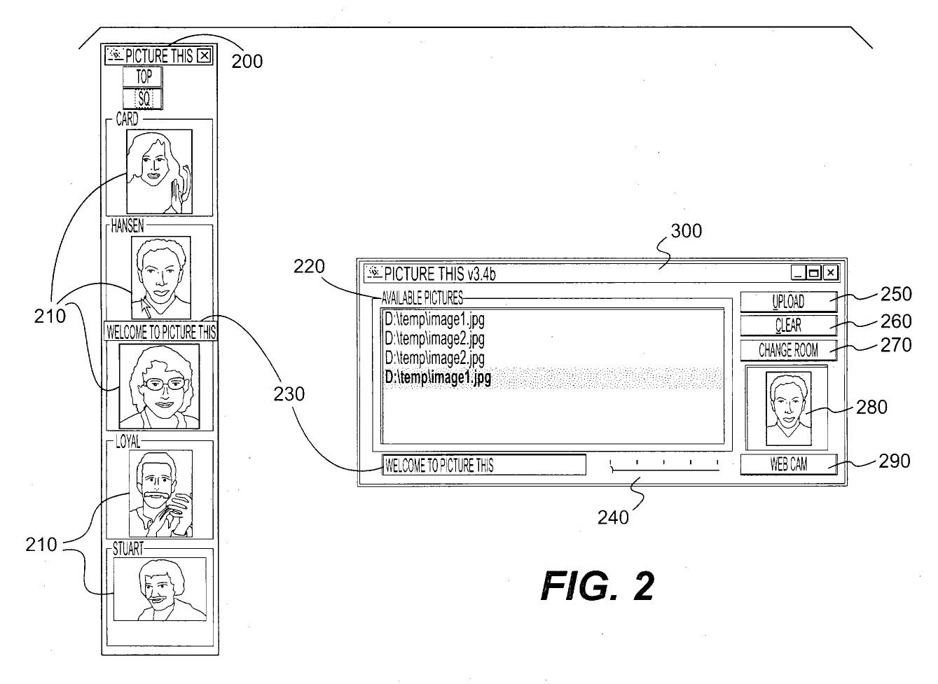

FIG. 2 shows an exemplary photo display window 200 and photo control window 300, preferably generated by the software application 107, that may be used in connection with the system and exemplary method for displaying expressive images for meetings. The photo display window 200 offers different window orientation options for displaying expressive images 210 of meeting participants. In this example, photographs of five meeting participants are displayed. The expressive images 210 may be pre-selected by each meeting participant using a photo control window 300 on each participant's computer 100.

Each meeting participant may have at least one collection of one or more images 210, such as digital photographs. Expressive images 210 may be selected by each meeting participant using a drag and drop picture list 220. Each image 210 may convey an expression, gesture, or other responses, such as applauding or glaring. Applauding, as a repetitive motion that may be interruptive in nature, may be displayed as a small video clip set repeating as long as the image is displayed. The images 210 may also convey emotions such as looking dubious or enthusiastic. In addition, the images 210 may show no one in the photograph, indicating that the person has temporarily moved away from the telephone or desk.

A meeting participant may have one collection of images 210 to use in multiple remote meetings. Alternatively, a meeting participant may have several collections intended for different purposes. For example, a meeting participant may have one collection of images 210 for formal meetings, showing the meeting participant formally dressed. The meeting participant may have another collection of images 210 for less formal meetings, showing the meeting participant in more casual attire. A sales person who works with customer companies with different dress codes may have different collections of images 210 corresponding to each of the dress codes. Similarly, a person working with groups in different countries, cultures, and languages may have multiple collections of images 210, each reflecting the body stances, gestures, and facial expressions associated with a specific language.

The expressive images 210 may be photographs of a meeting participant. However, other images 210 may be used, such as humorous images showing a sleeping animal to suggest that the meeting is putting the participant to sleep. In addition, drawings and video clips may be included in the collections. The images 210 may be captured in a variety of ways. For example, photographs of meeting participants may be captured during a meeting using a digital camera. Scanned hard-copy images and digital drawings may also be used.

The collections of images 210 may be saved in a storage device on a server (not shown). The images 210 can be accessed by the remote computers 100 during a meeting or downloaded by the remote computers 100 at the start of a meeting. The collections of images 210 may also be saved in a storage device 112 on each meeting participant's computer 100 for sharing during a meeting. Alternatively, the collections of images 210 may be stored on removable media. Each meeting participant's computer 100 may optionally store images of people that the participant meets frequently.

With continued reference to FIG. 2, the photo control window 300 may include a comments section 230 that allows the individual to enter text labels to be associated with the expressive images 210. For example, the phrase “Bravo!” may be associated with an image of a participant applauding, “Hmmm” may be associated with an image of a participant looking thoughtful and non-committal. The text labels may be part of the associating images 210. Alternatively, the text labels may be separate components of the system. More than one set of text labels may be associated with each collection of images, allowing the same image 210 to be used with different labels. The meeting participants may select the set of labels to be used for a specific meeting. For example, labels such as “Bravo!” and “It seems unlikely,” are suitable for formal meeting, whereas labels such as “Way to go!” and “Not a chance!” are typically used for informal meetings.

The text labels may be provided in more than one language. The meeting participants may select the preferred language to be used for a specific meeting.

The text labels may be relatively long or as short as “Yes!” or “No way!”. The text labels may serve the same purposes as muttered comments serve in face-to-face meetings, i.e., allowing participants to interject comments or questions in “asides” without formally interrupting the speaker and taking the floor.

The photo control window 300 may include configurable predefined standard text labels that may be selected from a drop-down menu. A team of participants may discuss, select, modify, add to, and agree on the definitions and uses for the predefined text labels for their team. The predefined text labels may be especially useful for cross-cultural teams that often face difficulties in communication. For example, one person's phrase for routine disagreement may be “That might be so,” while another's may be “That's crazy!”, and the difference in the different ways of expressing the same intention (routine disagreement) can cause misunderstandings. The default text labels may provide a common defined set of signals that all team members understand. Some examples of the predefined text labels are shown in Table 1.

TABLE 1

I have some concerns
Time constraints - how shall we pursue this?
Excellent work!
I need clarification before we move on
I have a question
I have an idea
I have a suggestion
I'd like to comment on this topic
I'd like to introduce a new topic
I volunteer for that
I disagree
I agree

With continued reference to FIG. 2, the comment section 230 may also include status comments that indicate the participant's status in the meeting. For example, “Away” indicates the participant is away from the meeting for an unspecified length of time and will not hear what takes place until returning, “Break?” suggests taking a break, “BRB” indicates be right back (away but intends to return promptly), and “AFK” indicates away from keyboard.

The photo control window 300 may also include a control device 240 to resize the selected image 210. The selected image 210 may then be uploaded 250, for example, at the start of a meeting. The selected image 210 may first be displayed as a thumbnail 280 before being uploaded. The images 210 may also be cleared using a clear icon 260. The photo control window 300 may optionally include other types of custom settings 270, including a control 290 enabling or disabling a web camera.

Video cameras may be used with the computers 100 to allow the meeting participants to capture and display real-time video during a meeting. Examples of real-time video include selected video frames or single frames captured at pre-set intervals.

The system may distinguish a speaker or key people in the audience from other meeting participants by displaying the expressive images 210 of the speaker or the key people in different color, in larger sizes, or in better resolution.

Participants may later be added to a meeting and their expressive images 210 may be arranged side by side horizontally, vertically, or in other arrangements, depending on spaces available on a particular display device 110.

The system may take advantage of color whenever color display devices 110 are available. Color is eye-catching, and enables participants to receive and interpret expressive information more effectively. For example, even if fifty murmur frames 200 appear on a display device 110, human eyes may readily recognize drastic color changes. Color coding may be standard. For example, green indicates agreement, red signals hostility, and white represents iciness. Color coding particularly benefits a speaker. Facing the display 110 with multiple expressive images 210 of meeting participants, the speaker may acknowledge an overall change of color from comers of his/her eyes, thus receiving feedback without having to study each individual image 210. Color coding is also useful when a large number of meeting participants are involved in a meeting. Each meeting participant's photograph may be correlated with color coding. The speaker or any other meeting participant can, for example, click on an area in red to view the actual images 210 of the meeting participants showing signs of disapproval.

In a face-to-face meeting, participants' laughter at a joke typically fades to a smile, then to a look of polite attention before being replaced by other expressions. Similarly, the system may have a default “baseline image” chosen by the user to represent his or her neutral state, and a “fade rate” that is set to control how long selected expressive images 210 will be displayed before changing back to the default baseline image. The participant may configure the default “fade rate” according to his/her preference, and may also override the default “fade rate” for a particular situation. For example, clicking to choose “applause” may show a meeting participant applauding for a few seconds. The same may be true of other expressive images 210 and text labels. The default “fade rate” for text labels may be configured separately from the expressive images 210.

One or more audio “frames” may be included with, for example, sound effects, background music, or various kinds of ambient noise, as long as the noises do not interrupt the main thread of the meeting and are clearly associated with the participant who triggers the noises. Additionally, appropriate audio separation may be provided to distinguish such an audio frame from the main audio discussion (for example, through the use of surround-sound that allows the audio frame to be assigned an audio “location” unmistakably distinct from the main discussion), so that the participants may appropriately use the audio frame for low-volume muttered (literally “murmured”) comments.

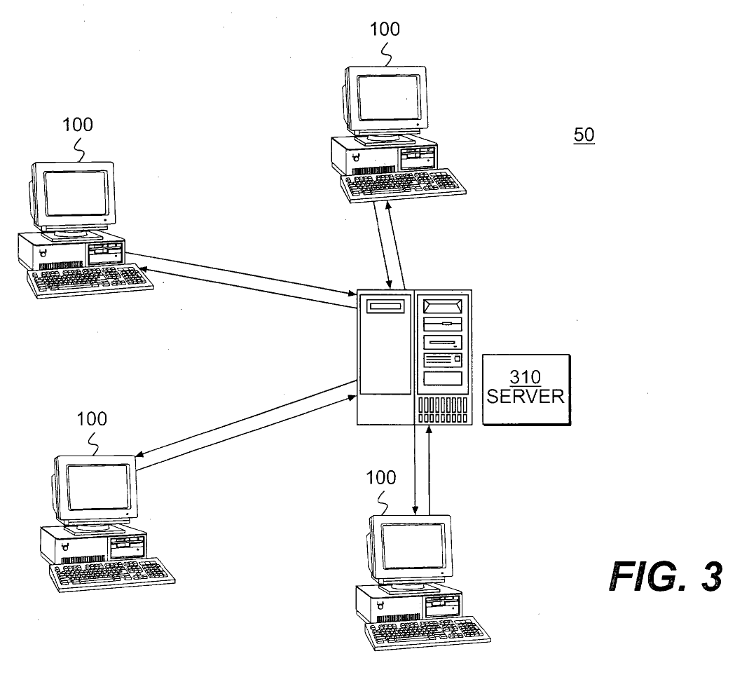

FIGS. 3-5 illustrate exemplary network connection models that may be used in connection with the system and exemplary method for communicating expressive images 210 for meetings. With respect to FIG. 3, an embodiment of the system 50 for communicating expressive images for meetings is shown. Each meeting participant's computer 100, i.e., a client computer in this example, is preferably connected to a server 310 or other network server. Each client computer 100 launches the software application 107 at the start of a remote meting, and selects a predetermined “meeting room” on the server 310 for sharing images 210. When a meeting participant updates his or her image 210, the updated image 210 maybe sent to the server 310 using, for example, file transfer protocol (FTP) or hypertext transfer protocol (HTTP). Other meeting participant's computer 100 may update the images 210 from the server 310 at a pre-set interval.

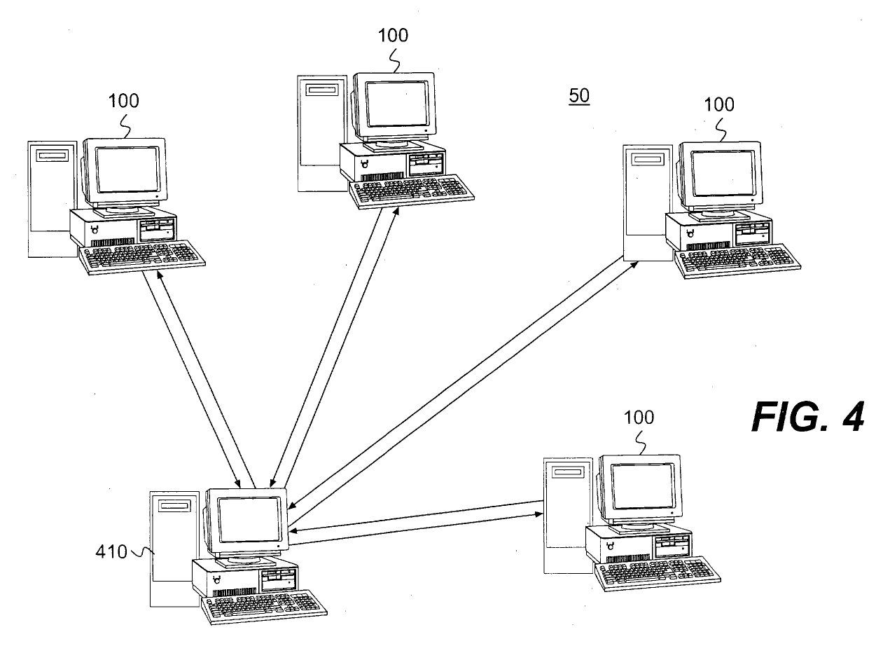

FIG. 4 illustrates a peer-to-peer model of the system 50 with a designated host. Multiple meeting participants' computers 100, client computers in this example, are connected to a designated host computer 410. Each client computer 100 launches the software application 107 at the start of a remote meting. Next, each client computer 100 may connect to the designated host computer 410. When a meeting participant updates his or her image 210, the updated image 210 may be sent to the designated host computer 410 to be distributed to the rest of the team.

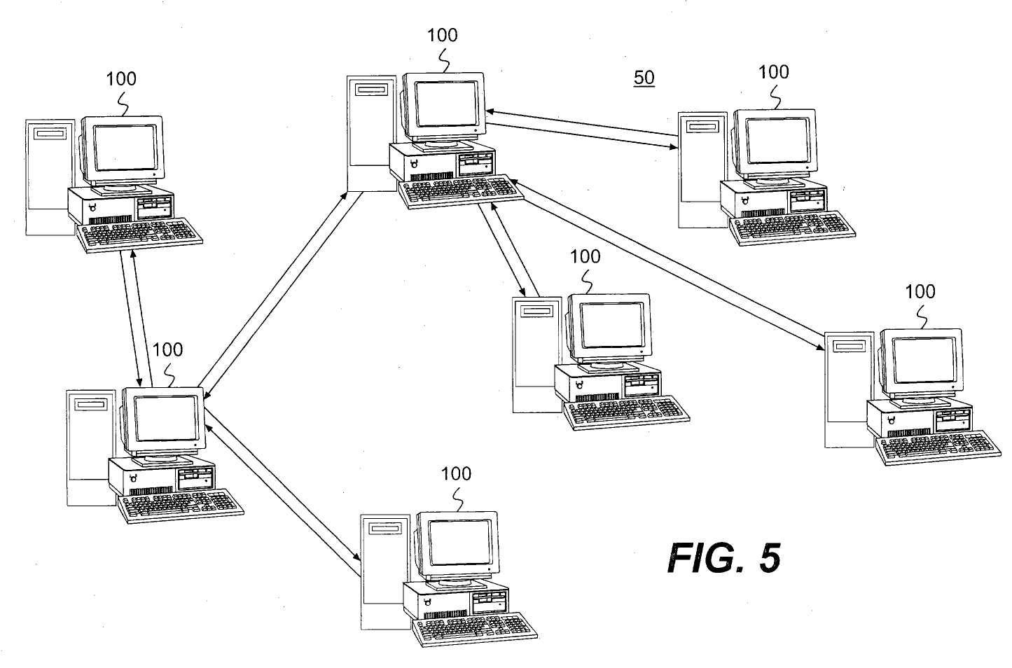

FIG. 5 illustrates a pure peer-to-peer model of the system 50. Each computer 100 launches the software application 107 at the start of a remote meting. Each computer 100 can be a host computer as well as a client computer. A client computer may connect to a host computer closest in location. When a meeting participant updates his or her image 210, the updated image 210 may be sent to the host computer 100, for example, the computer closest in location, to be distributed to the rest of the team.

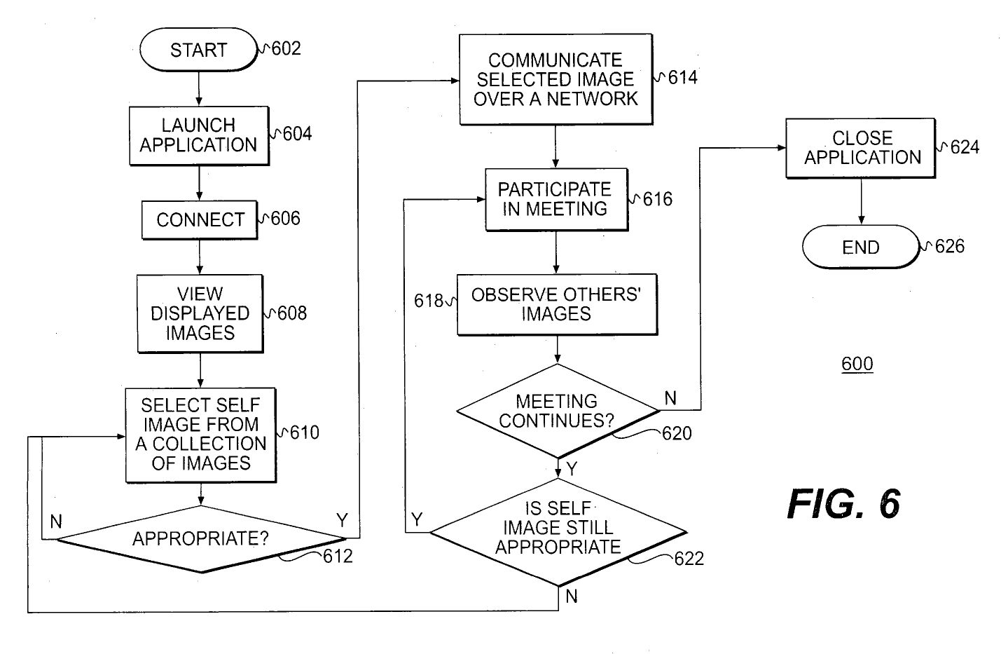

FIG. 6 is a flow chart illustrating the exemplary method 600 for communicating expressive images 210 for meetings. After a remote meeting starts (block 602), a meeting participant launches the software application 107 on his or her computer 100 (block 604). The computer 100 then connects with a server 310, a designated host computer 410 or a host computer closest in location (block 606). The meeting participant views multiple self images 210 stored in a storage device (block 608) and selects a self image 210 from the images collection (block 610). If the selection is not appropriate (block 612), the method goes back to block 610. If the selection is appropriate (block 612), the meeting participant communicates the selected image 210 to other meeting participants' computers 100 over the network 118 (block 614). The meeting participant then participates in the meeting (block 616). During the meeting, each meeting participant observes other meeting participants' images 210 (block 618). If the meeting continues (block 620), the meeting participant determines if the self image 210 is still appropriate (block 622). If yes, the meeting participant continues to participant in the meeting (block 616). However, if the self image 210 is no longer appropriate, the meeting participant selects another self image from the collection of images (block 610), and continues to participant in the meeting (block 616). If the meeting ends (block 620), the meeting participant closes the software application 107 on his or her computer 100 (block 624) and the method concludes (block 626).

While the system and method for communicating expressive images for meetings have been described in connection with an exemplary embodiment, those skilled in the art will understand that many modifications in light of these teachings are possible, and this application is intended to cover any variations thereof.

What is claimed is:

1. A system for communicating expressive images for a meeting, comprising:
a plurality of computers controlled by meeting participants;
a storage device capable of storing one or more collections of expressive images of each meeting participant;
a software application enabling each meeting participant to select an expressive image from the one or more collections of expressive images; and
a network connecting the plurality of computers,
wherein each meeting participant communicates the selected expressive image to other meeting participants over the network during the meeting.

2. The system of claim 1, wherein one or more of the plurality of computers are reduced functionality computing devices.

3. The system of claim 1, wherein expressive images are photographs of the meeting participant.

4. The system of claim 1, wherein the selected expressive image is transmitted to a server over the network.

5. The system of claim 1, wherein the selected expressive image is transmitted to a designated host over the network.

6. The system of claim 1, wherein the selected expressive image is transmitted to other computers on the network, and wherein each computer can simultaneously function as both a host and a client.

7. The system of claim 1, wherein the software application comprises modules for generating:
a photo control window capable of selecting the expressive image from the one or more collections of expressive images; and
a photo display window capable of displaying the selected expressive image on each meeting participant's computer.

8. The system of claim 1, wherein the software application allows each meeting participant to enter text labels associated with the selected one or more expressive images.

9. The system of claim 1, further comprising a digital camera operably connected to one of the plurality of computers for acquiring photographs of a meeting participant during a meeting.

10. The system of claim 1, further comprising a video camera operably connected to one of the plurality of computers for acquiring real-time video of a meeting participant during a meeting.

11. The system of claim 1, wherein the storage device is located on a server.

12. The system of claim 1, wherein the storage device is located on each meeting participant's computer.

13. A method for communicating expressive images for a meeting, comprising:
launching a software application on a computer controlled by a meeting participant;
connecting the computer to other meeting participants' computers over a network;
enabling the meeting participant to select a first expressive image from one or more collections of expressive images stored in a storage device; and
communicating the selected first expressive image to other meeting participants' computers over the network during the meeting.

14. The method of claim 13, further comprising enabling the meeting participant to select a second expressive image to replace the first expressive image, wherein the second expressive image is communicated to other meeting participants' computers over the network.

15. The method of claim 13, further comprising acquiring photographs of a meeting participant during a meeting using a digital camera operably connected to the computer.

16. The method of claim 13, further comprising acquiring real-time video of a meeting participant during a meeting using a video camera operably connected to the computer.

17. The method of claim 13, further comprising using a reduced function computing device for communicating the selected first expressive image and subsequent images.

18. The method of claim 13, further comprising enabling the meeting participant to enter text labels associated with the selected first expressive image.

19. A computer readable medium providing instruction for communicating expressive images for meetings, the instructions comprising:
launching a software application on a computer controlled by a meeting participant;
connecting the computer to other meeting participants' computers over a network;
enabling the meeting participant to select a first expressive image from one or more collections of expressive images stored in a storage device; and
communicating the selected first expressive image to other meeting participants' computers over the network during the meeting.

20. The computer readable medium of claim 19, further comprising instructions for acquiring photographs of a meeting participant during a meeting using a digital camera operably connected to the computer.

21. A system for communicating expressive images for a meeting, comprising:
means for connecting a computer controlled by a meeting participant to other meeting participants' computers over a network;
means for selecting a first expressive image by the meeting participant from one or more collections of expressive images stored in a storage device; and
means for communicating the selected first expressive image to other meeting participants' computers over the network during the meeting.
